(19) United States
(12) Patent Application Publication
(10) Pub. No.: US 2019/0349290 A1
(43) Pub. Date: Nov. 14, 2019

(54) IN-SITU OAM DATA BASED SEGMENT ROUTED PATH AND SERVICE FUNCTION VALIDATION

(71) Applicant: Cisco Technology, Inc., San Jose, CA (US)

(72) Inventors: Carlos M. Pignataro, Cary, NC (US); Frank Brockners, Köln (DE); Shwetha Subray Bhandari, Bangalore (IN); Nagendra Kumar Nainar, Morrisville, NC (US)

(21) Appl. No.: 15/975,956

(22) Filed: May 10, 2018

(51) Int. Cl. H04L 12/721; H04L 29/06; H04L 12/26

(52) U.S. Cl. CPC H04L 45/26; H04L 43/0847; H04L 69/22; H04L 45/34

(57) ABSTRACT

In one embodiment, expected path information is obtained that describes one or more possible paths to be taken by network traffic between an ingress node and an egress node in a network that includes a plurality of nodes each configured to populate an In-Situ Operations, Administration and Management (IOAM) header of packets with node identifier information indicating node transit of packets through the network. A packet is sent into the network, the packet including routing instructions for the packet to travel through the network. A plurality of node identifiers accumulated as the packet travels through the network are obtained from the IOAM header of the packet. The plurality of node identifiers represent actual path information for the actual path traveled by the packet. The path taken by the packet is validated based on a comparison of the actual path information with the expected path information.

### TECHNICAL FIELD

The present disclosure relates to network inband data collection and analysis.

### BACKGROUND

Service Level Agreement (SLA) compliance is one of the characteristics that network operators consider as part of service delivery. Recently developed technologies, like Segment Routing (SR), help a network operator to achieve SLA compliance by steering packets over one or more SLA-constrained paths. Segment Routing relies on centralized control plane intelligence for dynamic path computation and instantiation. A Path Computation Element (PCE) is a centralized controller/server that selects the minimum set of segments to traverse a specific (SLA-constrained) path.

### BRIEF DESCRIPTION OF THE DRAWINGS

FIG. 1 is a diagram of a network in which In-Situ Operations, Administration and Management (IOAM)-based path validation techniques are employed, according to an example embodiment.

FIG. 2 is a diagram of a network in which IOAM-based path validation techniques are employed, according to another example embodiment.

FIG. 3 is a diagram of a network in which IOAM-based path validation techniques are employed, according to still another example embodiment.

FIG. 4 is a diagram illustrating how actual path information is accumulated in an IOAM header of a packet as it travels through the network, according to an example embodiment.

FIG. 5 is a diagram illustrating when path validation fails, according to an example embodiment.

FIG. 6 is a high-level flowchart of a path validation method, according to example embodiments.

FIG. 7 is a block diagram of a network element configured to perform the operations presented herein, according to an example embodiment.

FIG. 8 is a block diagram of a server configured to perform the operations presented herein, according to an example embodiment.

### DESCRIPTION OF EXAMPLE EMBODIMENTS

### Overview

Techniques are presented herein for validating a path taken by traffic through a network. In one embodiment, expected path information is obtained that describes one or more possible paths to be taken by network traffic between an ingress node and an egress node in a network that includes a plurality of nodes each configured to populate an In-Situ Operations, Administration and Management (IOAM) header of packets with node identifier information indicating node transit of packets through the network. A packet is sent into the network, the packet including routing instructions for the packet to travel through the network. A plurality of node identifiers accumulated as the packet travels through the network are obtained from the IOAM header of the packet. The plurality of node identifiers represent actual path information for the actual path traveled by the packet. The path taken by the packet is validated based on a comparison of the actual path information with the expected path information. The packet that is used for path validation may be a probe packet or a data packet that is part of a normal network traffic flow.

### Example Embodiments

In-Situ Operations Administration and Management (IOAM) is an inband telemetry data collection technique. IOAM allows a network/service operator to collect real-time telemetry data by embedding the data inband within actual traffic. Such collected inband telemetry data allows a network/service operator to instantly react to any network events. The telemetry data collected by IOAM can be done on different layers. For example, a Hop-by-Hop option collects the path and/or performance data from each network element at the network layer. Alternately, the IOAM header can be included in a service header (like Segment Routing (SR), Network Service Header (NSH), and Generic Routing Encapsulation (GRE)) to collect the data from service nodes.

Presented herein are techniques that leverage IOAM to collect the path information and leverage Path Computation Element (PCE) intelligence to ensure that the segment/label stack is steering the packets over the desired path or paths. These techniques are applicable to Multi-Protocol Label Switching (MPLS), Segment Routing as well as Service Function chains.

The part of a network that employs IOAM may be referred to as the “IOAM domain”. IOAM data may be added to a packet upon entering the IOAM domain and is removed from the packet when exiting the domain. Within the IOAM domain, the IOAM data may be updated by network nodes that the packet traverses. The device which adds an IOAM data container to the packet to capture IOAM data is called the “IOAM encapsulating node”, whereas the device which removes the IOAM data container is referred to as the “IOAM decapsulating node”. Nodes within the domain which are aware of IOAM data and read and/or write or process the IOAM data are called “IOAM transit nodes”. IOAM nodes which add or remove the IOAM data container can also update the IOAM data fields at the same time. Or in other words, IOAM encapsulating or decapsulating nodes can also serve as IOAM transit nodes at the same time.

IOAM tracing data is collected at every node that a packet traverses to ensure visibility into the entire path a packet takes within an IOAM domain, i.e., in a typical deployment all nodes in an IOAM would participate in IOAM and thus be IOAM transit nodes, IOAM encapsulating or IOAM decapsulating nodes. If not all nodes within a domain are IOAM capable, IOAM tracing information will only be collected on those nodes which are IOAM capable. Nodes which are not IOAM capable will forward the packet without any changes to the IOAM data fields.

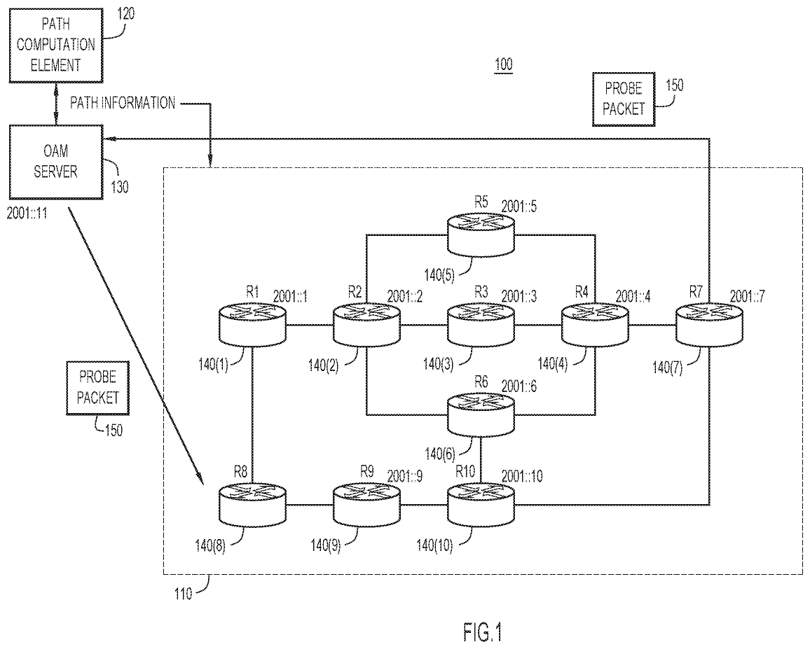

Reference is first made to FIG. 1. FIG. 1 shows a system 100 that includes a network 110 (or a domain of a network 110), a path computation element (PCE) 120 and an Operations Administration and Management (OAM) server 130. The PCE 120 and the OAM server 130 are in communication with each other. The network 110 includes a plurality of network elements R1-R10 at reference numerals 140(1)-140(10). The network 110 can have any number of network elements of various types in various topologies. The topology shown in FIG. 1 is only an example. Moreover, in one embodiment, each of the network elements are routers, but again, that is only an example. The network elements in network 110 could take on any of a variety of forms including switches, gateways, etc.

The PCE 120 may be a stand-alone server or computing apparatus that computes paths through the network 110 for traffic to traverse the network 110. The nodes 140(1)-140(N) can request for a path from the PCE 120. The PCE 120 computes a path and supplies path information to the nodes in the network 110 for that path. A situation may arise when a node in the network 110 directs a packet on a path that is not what the PCE 120 computed. Such a path may be referred to as an unintended path, and this may be caused by a programming corruption on a given node in the network.

In the topology shown in FIG. 1, the path using {2001:2, 2001:4, 2001:7} from ingress node R8 to egress node R7 can traverse one of the below paths:

### Path 1→{R8,R1,R2,R5,R4,R7}

### Path 2→{R8,R1,R2,R3,R4,R7}

### Path 3→{R8,R1,R2,R6,R4,R7}

In other words, Path 1, Path 2 and Path 3 are permitted/desirable/expected paths for the routing instructions represented by the segment stack: {2001:2, 2001:4, 2001:7}.

There are several different ways of implementing path validation, examples of which are described below. These methods take one of two forms: (1) a strict mechanism that is applied for all (customer) traffic all the time, or (2) an indicative mechanism that is applied for probe traffic or a subset (not all) customer traffic.

Centralized OAM Server Based Validation—Indicative Mechanism

In this embodiment, the centralized OAM server (defined in draft-ietf-spring-oam-usecase) 130 obtains the path information from the PCE server 120 and sends a probe packet 150 into the network. Upon receiving the probe packet back (with IOAM data collected), it uses the IOAM data to compare with the above path information for path validation.

In this example, the OAM server 130 triggers/generates a probe packet 150 with segment stack as {2001:2, 2001:4, 2001:7, 2001:11} and an IOAM header inserted. In one example, the path information includes path information for Path 1, Path 2 and Path 3 above. Each of the network elements in the network 110 populates the IOAM header of the probe packet 150 with information indicating that the probe packet transited that network element. Thus, when the probe packet 150 returns to the OAM server 130, as shown in FIG. 1, the OAM server 130 can extract the contents of the IOAM header of the probe packet. Using the path information obtained from the PCE 120, the OAM server 130 can compare the expected path information (computed by the PCE 120) with the actual path traveled (as represented by data contained in the IOAM header of the probe packet 150) to determine whether there is a match. If there is not a match, then a failure occurred in the network 110. The OAM server 130 can generate an alert to a network administrator.

The centralized OAM server-based validation approach is an indicative mechanism because it is invoked when there is some indication or need for path validation. It is not necessarily being performed all the time.

Ingress Node Based Validation—Indicative Mechanism

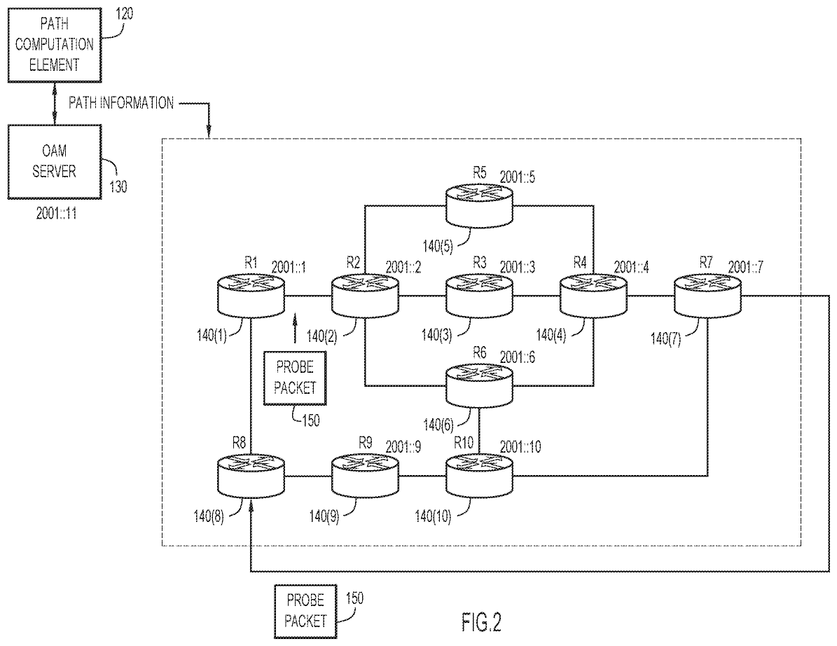

FIG. 2 shows a network environment similar to FIG. 1, except that the ingress node, e.g., node R8, triggers/generates the probe packet 150 and has the probe packet 150 return to it where path validation is performed. This approach, like that shown in FIG. 1, is an indicative mechanism because it is usually not always being performed.

Egress Node Based Validation—Strict Mechanism or Indicative Mechanism

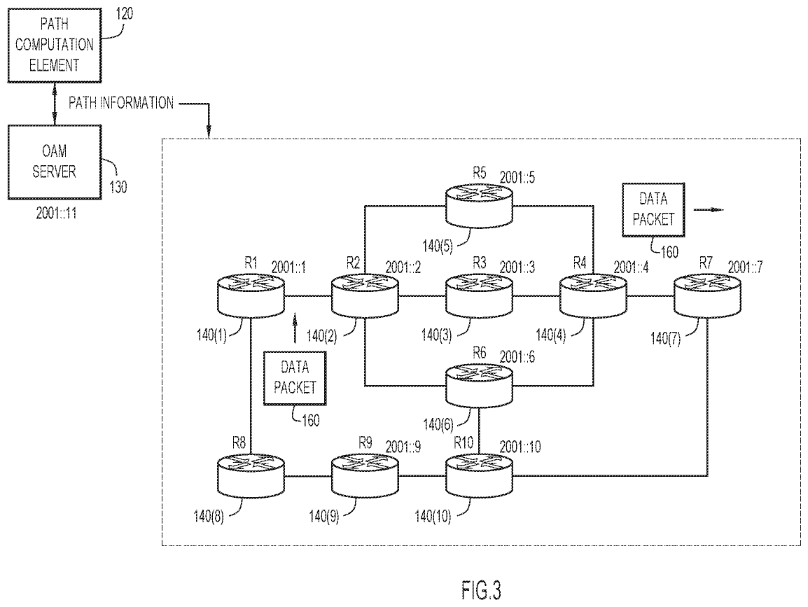

FIG. 3 shows a network environment similar to FIG. 1, but the egress node performs path validation on the data traffic itself, as shown by data packet 160 (instead of a probe packet). In the example of FIG. 3, the egress node R7 obtains from the PCE 120 the path information for all paths (that it acts as egress). The ingress node, e.g., node R8, will insert an IOAM header in data traffic packets. The egress node extract from data packets the IOAM data populated by network elements along the path through the network 110 perform for path validation.

Egress node based path validation may be operated in a strict mechanism form in which it is implemented all the time for all customer traffic. However, egress node based path validation may also be operated in an indicative mechanism where it is employed a subset (not all) customer traffic, such as only during certain time periods or when an indication arises that necessitates path validation.

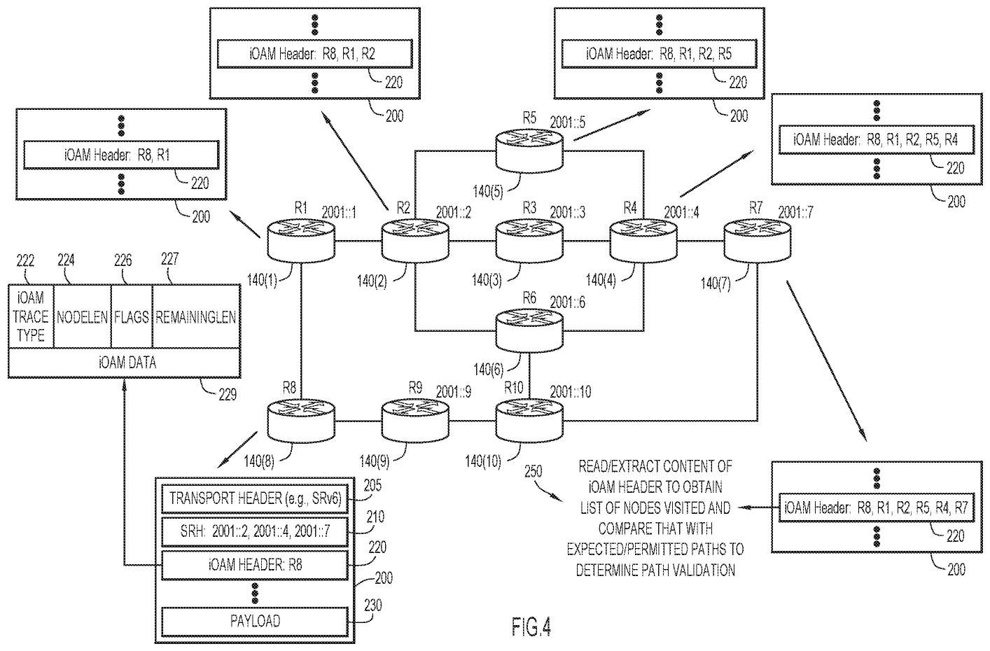

Reference is now made to FIG. 4. FIG. 4 provides a more detailed pictorial representation of the path validation technique, showing the contents of the relevant fields of a packet 200 as the packet travels through various nodes the network 110. The packet (probe packet or data packet) 200 starts traveling on its path at ingress node R8. The packet 200 includes a plurality of headers including a transit or transport header 205, a routing instructions header 210 and an IOAM header 220, as well as a payload field 230. The transport header 205 indicates the transport protocol used, such as SRv6, or any other transport protocol applicable for use with the IOAM-based path validation techniques described herein. The routing instructions header 210 may be included a Segment Routing Header (SRH), and includes path information, for example, a segment list identifying the path of data packet 200 through network 110. In this example, the routing instructions are in the form of a segment list: 2001:2, 2001:4, 2001:7.

The IOAM header 220 may include additional information, such as IOAM Trace Type field 222, Node Length (NodeLen) field 224, Flag field 226, and Remaining Length (RemainingLen) field 227 and IOAM data field 229.

FIG. 4 shows the packet 200 as it travels through the network at each node it transits. To simplify the diagram, only the contents of the IOAM header 220 is shown after the packet 200 leaves the ingress node R8.

When the packet 200 transits node R8, node R8 populates in the IOAM data field 229 of IOAM header 220 “R8” to indicate that the packet has transited node R8. (For simplicity, the content of the IOAM data field 229 is shown in IOAM header 220 in packet 200.) The packet 200 then is received by node R1 from node R8. Node R1 adds to the IOAM header 220 “R1” to augment the existing content of the IOAM header 220. Thus, when the packet leaves node R1, the IOAM header 220 contains data representing “R8, R1”.

The packet 200 next is forwarded to node R2. Node R2 adds to the IOAM header 220 “R2” and when the packet 200 leaves node R2, the IOAM header 220 contains data representing “R8, R1, R2”.

In this example, R2 forwards the packet 200 to node R5. Node R5 adds to the IOAM header 220 “R5” and thus when the packet 200 leaves node R5, the IOAM header 220 contains data representing “R8, R1, R2, R5”.

Node R5 forwards the packet 200 to node R4. Node R4 adds to the IOAM header 220 “R4” such that when the packet 200 leaves node R4, the IOAM header 220 contains data representing “R8, R1, R2, R5, R4”.

Finally, in this example, node R4 forwards the packet 200 to the egress node R7. Node R7 adds to the IOAM header 220 “R7”. Thus, the packet 200 now includes in IOAM header 220 data representing “R8, R1, R2, R5, R4, R7”.

As described above, the IOAM header 220 can be included in a packet encapsulated using a Segment Routing (SR) header, Network Service Header (NSH), Generic Routing Encapsulation (GRE) header, as well as Internet Protocol version 6 (IPv6), etc., to collect the data from nodes as the packet travels through the network.

Whatever entity performs path validation (OAM Server 130, ingress node or egress node), that entity will read/extract the content of IOAM header 220 of the packet 200, as shown at 250 in FIG. 4. In the example of FIG. 4, IOAM data representing “R8, R1, R2, R5, R4, R7” will be obtained at 250. This data is the actual path information. The validating entity compares the actual path information with the expected/permitted/desired path information. For example, the path information presented in the example above for Path 1, Path 2 and Path 3 is the expected/permitted/desired path information. In this example, the validating entity will determine that the actual path of the packet matches one of the paths of the expected/permitted/desired path information, that is, Path 1. Therefore, the packet 200 passes path validation.

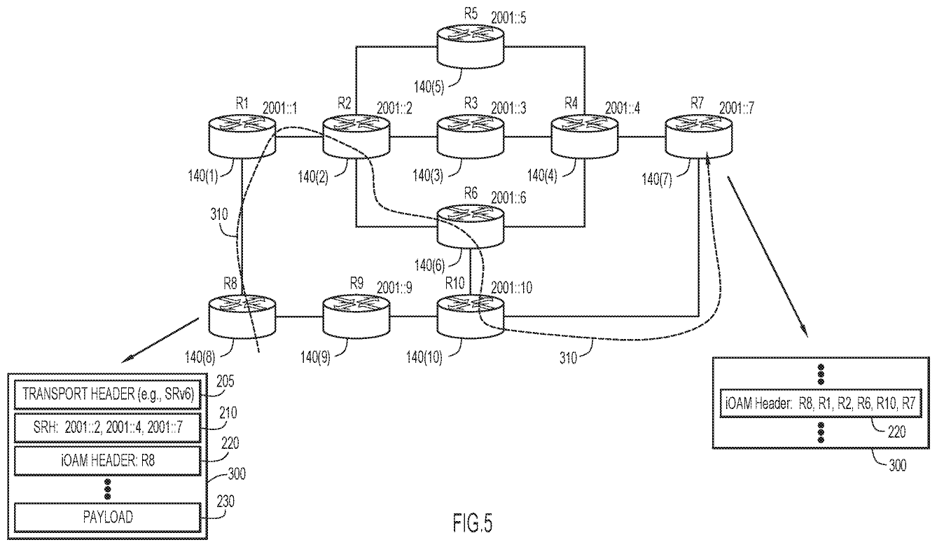

Reference is now made to FIG. 5 to illustrate an example of when path validation failure is detected. The path of a packet (data packet or probe packet) 300 is shown at reference numeral 310. When the packet 300 is mis-forwarded by node R6 to node R10 (for traffic destined to 2001:4), and the packet 300 reaches egress node R7, the packet 300 will collect/accumulate IOAM data as {R8, R1, R2, R6, R10, R7}, as shown in FIG. 5. The actual path information {R8, R1, R2, R6, R10, R7} does not match with the expected path information of Path 1, Path 2 or Path 3. Thus, a failure will be detected during path validation.

The embodiments presented herein allow a network operator to detect any deviation in paths instantly by leveraging the capabilities of IOAM to take any necessary action, such as reprogramming/configuring a network element, replacing a network element, changing the network topology, etc., when a path validation failure is detected.

Referring back to FIG. 1, the path validation techniques described above may be applied to service function path validation. For example, nodes R2, R4 and R7 are service function forwarding nodes and nodes R5, R3 and R6 are service functions, such as Deep Packet Inspection, Load Balancing, Intrusion Protection, etc. The overall operational logic is the same as the use cases described above, but instead of validating a network path, validation is made of a forwarding construct, service construct or combination thereof, for service function path validation.

The foregoing describes that path validation is performed at an egress node or even off-box (e.g., at an OAM server). This is not meant to be limiting as path validation can also be performed in-transit. For example, referring to FIGS. 4 and 5, an in-transit node, such as R10, may be configured to populate the IOAM header as described above, and to examine the SRH 210. If R10 sees traffic from R2 destined to R4 (forced by the SRH 210), then it can generate and send an alert indicating that something has gone wrong because a traffic from R2 has taken an unintended/unexpected path. To perform this operation, a control entity, such as the path computation element 120 or OAM server 130 (FIG. 1) would send commands to the in-transit node, e.g., R10, providing it with the expected path information for certain traffic so that the in-transit node could use that path information to perform path validation and generate an alert when traffic hits that in-transit node indicating that traffic has taken the wrong path.

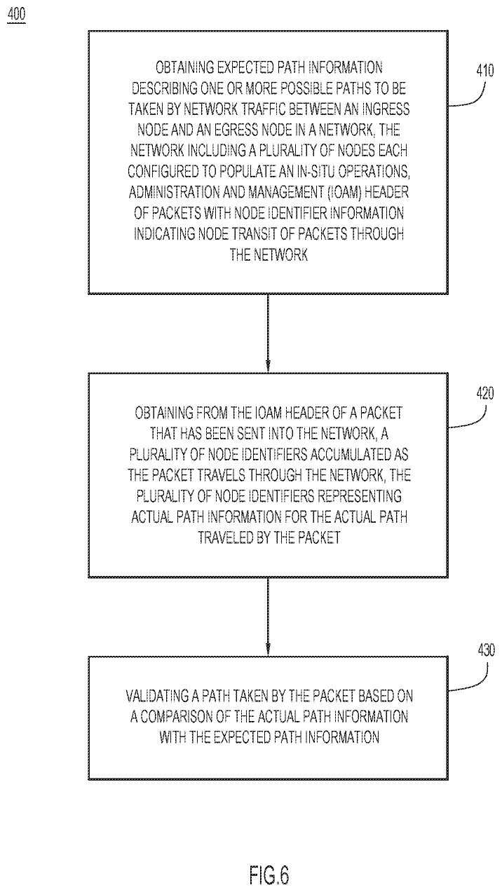

Reference is now made to FIG. 6. FIG. 6 illustrates a flow chart of a method 400 according to the path validation techniques presented herein. At 410, expected path information is obtained. The expected path information describes one or more possible paths to be taken by network traffic between an ingress node and an egress node in a network. The network includes a plurality of nodes each configured to populate an In-Situ Operations, Administration and Management (IOAM) header of packets with node identifier information indicating node transit of packets through the network.

As an example, a PCE may compute the expected path information based on routing instructions to be included in a packet to travel through the network between the ingress node and the egress node. The obtaining operation 410 may be performed by the OAM server, the ingress node or the egress node, as described above.

A packet that includes the routing instructions, is sent into the network to travel through the network from the ingress node to the egress node. The packet may be sent into the network by the OAM server or by the ingress node. The packet may be a probe packet that is generated based on the routing instructions obtained from a path computation element, or a data packet that is part of normal network traffic.

At 420, a plurality of node identifiers are obtained from the IOAM header of the packet. The plurality of node identifiers are accumulated in the IOAM header as the packet travels through the network, and the plurality of node identifiers represent actual path information for the actual path traveled by the packet between the ingress node and egress node of the network. Operation 420 may be performed by the OAM server, the ingress node, the egress node, or an in-transit node, as described above.

At 430, the path taken by the packet through the network is validated based on a comparison of the actual path information with the expected path information. Again, operation 430 may be performed by the OAM server, ingress node, egress node or an in-transit node, as described above.

The validation operation 430 may involve validating the path taken by the packet when the actual path information matches the expected path information, or generating a failure indication when the actual path information does not match the expected path information.

As explained above, the routing instructions may be specified in terms of one or more of: a stack or list of Segment Routing (SR) segment identifiers, stack or list of Multi-Protocol Label Switching (MPLS) labels, or service function path information. In one form, the validation operation 430 involves validating a forwarding construct, service construct or combination thereof, for service function path validation.

As described above, the packet may be a probe packet that is generated based on routing instructions obtained from a path computation element. In one form, operations 410, 420 and 430 may be performed by a server that is in communication with the path computation element. In another form, operations 410, 420 and 430 may be performed by the ingress node. Furthermore, the probe packet may be generated when path validation in the network is indicated, that is, when some condition is observed or determined that necessitates path validation.

The packet may be a data packet that is part of a network traffic flow. In one form, the operations 410, 420 and 430 may be performed at the egress node. In another form, the operations 410, 420 and 430 may be performed at an in-transit node in the network using routing instructions obtained from the packet by the in-transit node. Moreover, the validation operation may be performed for all packets of the network traffic flow all the time for strict path validation, or for a subset of packets of the network traffic flow when path validation in the network is indicated.

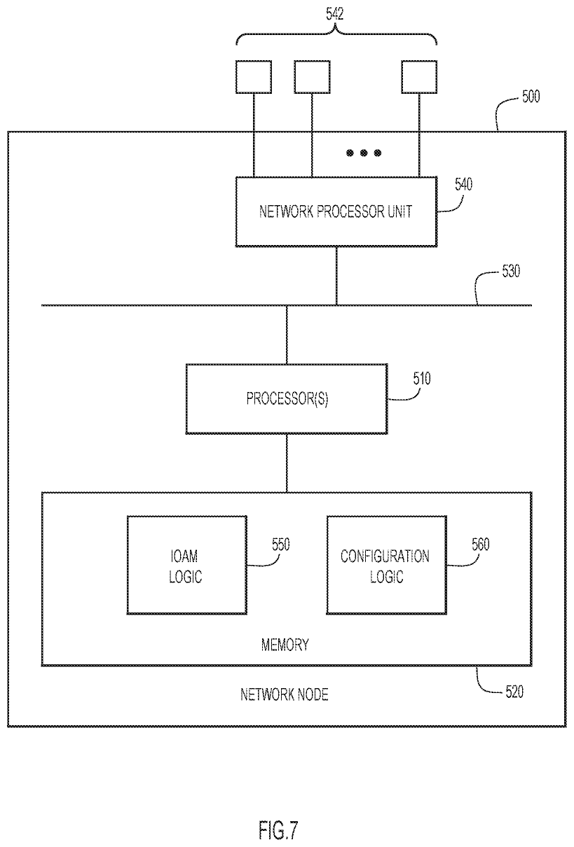

Reference is now made to FIG. 7. FIG. 7 illustrates a block diagram of a network element (node) 500 configured to perform the network node operations described in connection with FIGS. 1-6. The network node 500 includes one or more control processors 510, memory 520, a bus 530 and a network processor unit 540. The control processor 510 may be a microprocessor or microcontroller. The network processor unit 540 may include one or more Application Specific Integrated Circuits (ASICs) and facilitates network communications between the node 500 and other network nodes as well as with the PCE 120 and OAM server 130 as shown in FIG. 1. Moreover, the network processor unit 540 may be configured to encapsulate a packet to include an IOAM header, and to decapsulate a packet that includes an IOAM header.

There are a plurality of network ports 542 at which the node 500 receives packets and from which the node 500 sends packets into the network. The processor 510 executes instructions associated with software stored in memory 520. Specifically, the memory 520 stores instructions for IOAM logic 550 that, when executed by the processor 510, causes the processor 510 to perform the IOAM insertion operations described herein or to control the network processor unit 540 to perform the IOAM insertion operations described herein. The memory 520 also stores configuration information 560 received from a network controller to configure the network node according to desired network functions. It should be noted that in some embodiments, the IOAM logic 550 may be implemented in the form of firmware that is processed by ASICs as part of the network processor unit 540.

The memory 520 may include read only memory (ROM) of any type now known or hereinafter developed, random access memory (RAM) of any type now known or hereinafter developed, magnetic disk storage media devices, tamper-proof storage, optical storage media devices, flash memory devices, electrical, optical, or other physical/tangible memory storage devices. In general, the memory 520 may comprise one or more tangible (non-transitory) computer readable storage media (e.g., a memory device) encoded with software comprising computer executable instructions and when the software is executed (by the processor 510) it is operable to perform the network node operations described herein.

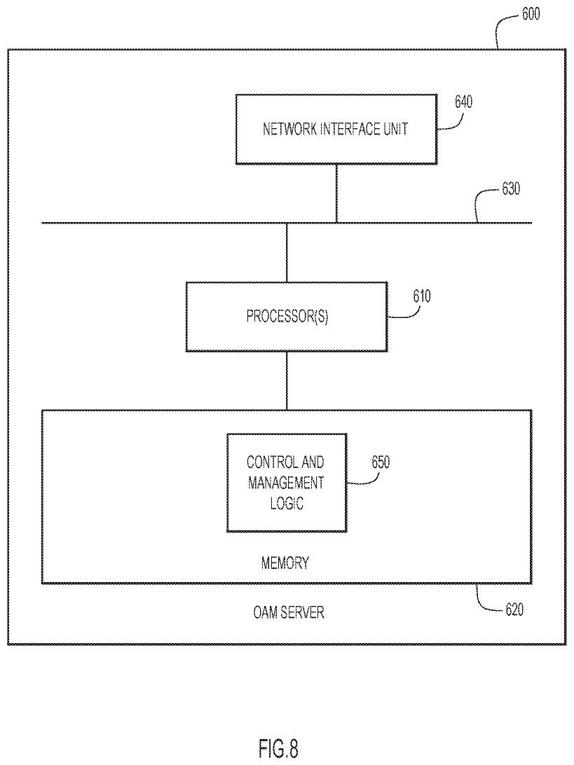

Reference is now made to FIG. 8. FIG. 8 illustrates a block diagram of a computing/control entity 600 that may perform the functions of the network controller OAM server 130 described herein. The computing/control entity 600 includes one or more processors 610, memory 620, a bus 630 and a network interface unit 640, such as one or more network interface cards that enable network connectivity. The memory 620 stores instructions for control and management logic 650, that when executed by the processor 610, cause the processor to perform the OAM server operations described herein.

The memory 610 may include ROM of any type now known or hereinafter developed, RAM of any type now known or hereinafter developed, magnetic disk storage media devices, tamper-proof storage, optical storage media devices, flash memory devices, electrical, optical, or other physical/tangible memory storage devices. In general, the memory 620 may comprise one or more tangible (non-transitory) computer readable storage media (e.g., a memory device) encoded with software comprising computer executable instructions and when the software is executed (by the processor 610) it is operable to perform the network controller operations described herein.

In summary, in one form, a method is provided involving: obtaining expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network; obtaining from the IOAM header of a packet that has been sent into the network, a plurality of node identifiers accumulated as the packet travels through the network, the plurality of node identifiers representing actual path information for the actual path traveled by the packet; and validating a path taken by the packet based on a comparison of the actual path information with the expected path information.

In another form, an apparatus is provided comprising a network interface including a plurality of ports configured to send network traffic into a network and receive network traffic from the network; and a processor coupled to the network interface, wherein the processor is configured to: obtain expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network; obtain from the IOAM header of a packet that has been sent into the network, a plurality of node identifiers accumulated as the packet travels through the network, the plurality of node identifiers representing actual path information for the actual path traveled by the packet; and validate a path taken by the packet based on a comparison of the actual path information with the expected path information.

In yet another form, one or more non-transitory computer readable storage media are provided encoded with instructions that, when executed by a processor, cause the processor to perform operations including: obtaining expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network; obtain from the IOAM header of a packet that has been sent into the network, a plurality of node identifiers accumulated as the packet travels through the network, the plurality of node identifiers representing actual path information for the actual path traveled by the packet; and validate a path taken by the packet based on a comparison of the actual path information with the expected path information.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

1. A method comprising:
obtaining expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network;
obtaining from the IOAM header of a packet that has been sent into the network, a plurality of node identifiers accumulated as the packet travels through the network, the plurality of node identifiers representing actual path information for an actual path traveled by the packet; and
determining whether the actual path can be validated based on a comparison of the actual path information with the expected path information, and
if it is determined that the actual path cannot be validated, causing a corrective action to be taken on a network element in the actual path or in the one or more possible paths.

2. The method of claim 1, further comprising:
determining that the actual path can be validated when the actual path information matches the expected path information.

3. The method of claim 1, further comprising:
generating a failure indication when the actual path information does not match the expected path information.

4. The method of claim 1, wherein the packet includes routing instructions used for routing of the packet in the network, wherein the routing instructions are specified in terms of one or more of: a stack or list of Segment Routing (SR) segment identifiers, stack or list of Multi-Protocol Label Switching (MPLS) labels, or service function path information.

5. The method of claim 1, wherein determining whether the actual path can be validated includes determining whether a forwarding construct, service construct or combination thereof, can be validated for service function path validation.

6. The method of claim 1, wherein the packet is a probe packet generated based on routing instructions obtained from a path computation element.

7. The method of claim 6, wherein obtaining the expected path information, obtaining the plurality of node identifiers from the IOAM header, and determining whether the actual path can be validated are performed at a server that is in communication with the path computation element.

8. The method of claim 6, wherein obtaining the expected path information, obtaining the plurality of node identifiers from the IOAM header, and determining whether the actual path can be validated are performed at the ingress node.

9. The method of claim 6, further comprising generating the probe packet when path validation in the network is indicated.

10. The method of claim 1, wherein the packet is a data packet that is part of a network traffic flow.

11. The method of claim 10, wherein obtaining the expected path information, obtaining the plurality of node identifiers from the IOAM header and determining whether the actual path can be validated are performed at the egress node.

12. The method of claim 10, wherein obtaining the expected path information, obtaining the plurality of node identifiers from the IOAM header and determining whether the actual path can be validated are performed at an in-transit node in the network using routing instructions obtained from the packet by the in-transit node.

13. The method of claim 10, wherein determining whether the actual path can be validated is performed for all packets of the network traffic flow at all times for strict path validation, or for a subset of packets of the network traffic flow when path validation in the network is indicated.

14. An apparatus comprising:
a network interface including a plurality of ports configured to provide or obtain network communications; and
a processor coupled to the network interface, wherein the processor is configured to:
obtain expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network;
obtain from the IOAM header of a packet that has been sent into the network, a plurality of node identifiers accumulated as the packet travels through the network, the plurality of node identifiers representing actual path information for an actual path traveled by the packet; and
determine whether the actual path can be validated based on a comparison of the actual path information with the expected path information; and
if it is determined that the actual path cannot be validated, cause a corrective action to be taken on a network element in the actual path or in the one or more possible paths.

15. The apparatus of claim 14, wherein the processor is further configured to:
determine that the actual path can be validated when the actual path information matches the expected path information, and to generate a failure indication when the actual path information does not match the expected path information.

16. The apparatus of claim 14, wherein the packet includes routing instructions used for routing of the packet in the network, wherein the routing instructions are specified in terms of one or more of: a stack or list of Segment Routing (SR) segment identifiers, stack or list of Multi-Protocol Label Switching (MPLS) labels, or service function path information.

17. The apparatus of claim 14, wherein the processor is configured to determine whether the actual path can be validated by determining whether a forwarding construct, service construct or combination thereof, can be validated for service function path validation.

18. The apparatus of claim 14, wherein the packet is a probe packet, and the processor is configured to generate the probe packet based on routing instructions.

19. The apparatus of claim 18, wherein the packet is a data packet that is part of a network traffic flow.

20. One or more non-transitory computer readable storage media encoded with instructions that, when executed by a processor, cause the processor to perform operations including:
obtaining expected path information describing one or more possible paths to be taken by network traffic between an ingress node and an egress node in a network, the network including a plurality of nodes each configured to populate an In-Situ Operations, Administration and Management (IOAM) header of packets with node identifier information indicating node transit of packets through the network;
obtaining from the IOAM header of a packet that has been sent into the network, a plurality of node identifiers accumulated as the packet travels through the network, the plurality of node identifiers representing actual path information for an actual path traveled by the packet; and
determining whether the actual path can be validated based on a comparison of the actual path information with the expected path information; and
if it is determined that the actual path cannot be validated, causing a corrective action to be taken on a network element in the actual path or in the one or more possible paths.

21. The one or more non-transitory computer readable storage media of claim 20, wherein the instructions further cause the processor to perform operations including:
determining that the actual path can be validated when the actual path information matches the expected path information; and
generating a failure indication when the actual path information does not match the expected path information.

22. The one or more non-transitory computer readable storage media of claim 20, wherein the packet includes routing instructions used for routing of the packet in the network, wherein the routing instructions are specified in terms of one or more of: a stack or list of Segment Routing (SR) segment identifiers, stack or list of Multi-Protocol Label Switching (MPLS) labels, or service function path information.

23. The one or more non-transitory computer readable storage media of claim 20, wherein the operation of determining whether the actual path can be validated includes determining whether a forwarding construct, service construct or combination thereof, can be validated for service function path validation.
